(19) United States
(12) Patent Application Publication
(10) Pub. No.: US 2012/0240048 A1
(43) Pub. Date: Sep. 20, 2012

(54) IMAGING EXTENSIBILITY FOR DEVICE MANAGEMENT PLATFORMS

(75) Inventors: Dominique Fortier, Issaquah, WA (US); Jonathan Hutchinson, Snohomish, WA (US); Artem Zhurid, Bellevue, WA (US); Tobiasz Zielinski, Monroe, WA (US)

(73) Assignee: Microsoft Corporation, Redmond, WA (US)

(21) Appl. No.: 13/051,722

(22) Filed: Mar. 18, 2011

(51) Int. Cl. G06F 15/177; G06F 3/048; G06F 9/46

(52) U.S. Cl. 715/736; 718/100

(57) ABSTRACT

Techniques for managing a variety of types of client devices from a device management platform are provided herein. At least one client device is selected to have a management task performed, such as an imaging task. The client device(s) is/are coupled to a client administration system that administers the client device(s). A deployment job is generated for the management task. A begin request is transmitted to a plug-in module of the client administration system to begin the deployment job. The plug-in module is customized to be capable of managing received deployment jobs for the client administration system. The plug-in module enables the deployment job to be performed on the client device(s) in response to the begin request.

### BACKGROUND

Configuration management relates to the establishing and maintaining of consistency in a system's performance, and of the functional and physical attributes of the system. For instance, with regard to a device network, a configuration management application may be configured to assess, deploy, and update servers, client computers, and other devices. The configuration management application may also handle maintaining the consistency of software across the device network.

In some environments, devices running embedded operating systems may need to be updated and/or serviced in a consistent fashion. For example, an operating system running on the devices may need to be “re-imaged,” such that the operating system is removed and a new operating system installed on the devices. In many cases, the re-imaging of the devices has to be accomplished using techniques that are proprietary to the manufacturer of the devices. This introduces a complexity to a configuration management system that manages a variety of devices in a single environment (such as an enterprise). If there are different types of devices present in the environment, different proprietary management applications are typically used to re-image each type of device. Different proprietary management systems typically have different interfaces and entry points, and different ways of being used, and as such are difficult to manage together in a common environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for enabling management tasks to be performed on various types and configurations of client devices that are managed by their own client administrative systems. A common interface is provided that enables deployment jobs to be generated and performed. Each client administrative system has a plug-in module installed that receives deployment jobs from the common interface, and that enables the corresponding tasks to be performed on the client devices. The plug-in module also enables status information regarding the progress of a deployment job to be delivered back to the common interface.

For instance, in one implementation, a method for managing client devices is provided. One or more client devices are coupled to a client administration system that administers the client device(s). At least one client device is selected for imaging. A deployment job is generated for imaging the client device(s). A begin request is transmitted to a plug-in module of the client administration system to begin the deployment job. The plug-in module is customized to be capable of managing received deployment jobs for the client administration system. The plug-in module enables the deployment job to be performed on the client device(s) in response to the begin request.

In another implementation, a configuration management system is provided. The configuration management system includes a device imaging interface that is configured to transmit a begin request to a plug-in module at a client administration system to begin a deployment job. The plug-in module enables the deployment job to be performed on at least one client device administered by the client administration system in response to receiving the begin request,

Furthermore, the configuration management system may include a user interface module. The user interface module generates a user interface that enables one or more client devices to be selected for imaging in the deployment job, and an image file to be selected, to be applied to the client devices in the deployment job. Furthermore, a plug-in module may be selected from a user interface generated by the user interface module.

In still another implementation, a plug-in module for a client administration system is provided. The plug-in module includes a manager interface and imaging logic. The manager interface is configured to enable communications with a configuration management system. The communications include a begin request received from the configuration management system for the plug-in module to begin a deployment job. The imaging logic is configured to enable the deployment job to be started on at least one client device associated with the client administration system in response to receiving the begin request.

Computer program products are also described herein for managing devices, for plug-in modules, for configuration management systems, and for further embodiments as described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a configuration management environment that includes a client management system that communicates with a plug-in module at a client administration system that administers a client device according to an example embodiment.

FIG. 2 shows a flowchart providing a process for managing client devices, according to an example embodiment.

FIG. 3 shows a block diagram of a configuration management environment that includes multiple client administration systems and client devices, according to an example embodiment.

FIG. 4 shows a block diagram of an example client device.

FIG. 5 shows a block diagram of a configuration management environment, according to an example embodiment.

FIG. 6 shows a flowchart providing a process for imaging client devices, according to an example embodiment.

FIG. 7 shows a block diagram of a configuration management environment, according to an example embodiment.

FIG. 8 shows a flowchart providing a process for imaging client devices, according to an example embodiment.

FIG. 9 shows a flowchart providing a process for imaging client devices, according to an example embodiment.

FIG. 10 shows a flowchart providing a process for imaging client devices, according to an example embodiment.

FIG. 11 shows a block diagram of an example plug-in module, according to an embodiment.

FIG. 12 shows a flowchart providing a process for providing a status of a deployment job, according to an example embodiment.

FIG. 13 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described, in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It noted that any section/subsection headings provided herein are not intended to be limiting. Embodiments are described throughout this document, and any type of embodiment may be included under any section/subsection.

### II. Example Embodiments

Embodiments provide techniques for managing different types of devices in an environment, including enabling the performing of imaging and other management tasks associated with the devices. For example, in an environment, multiple types of client devices may be present that are administered by different types of administrative systems (e.g., proprietary client administrative systems). In an embodiment, an extensibility model is provided for a management system or platform that facilitates the integration of multiple types of administrative systems such that various types of client devices may be centrally managed. The management system provides a common interface for managing the different types of client devices through the different types of administrative systems. In embodiments, similar tasks are performed by the different types of administrative systems based on the corresponding client devices types.

In an embodiment, “plug-in” modules or components may be integrated into the administrative systems. The plug-in modules extend the native capabilities of a management system to enable the management system to service the different administrative systems. Through the plug-in modules, the management system can perform management tasks with regard to the different types of client devices.

In an embodiment, the management system functions as an interface for command and control of deployment jobs to be performed on the client devices, including imaging jobs. The management system may provide a user interface through which deployment jobs may be configured and/or modified, and the progress/status of deployment jobs may be captured and reported to an end user through the user interface. The management system is agnostic to the imaging techniques that may be used, as well as the data format, protocol, and transport used to communicate with the administrative systems.

As such, in embodiments, an extensible management system or platform is provided, for managing (e.g., imaging) proprietary client devices in a protocol, format, and/or transport agnostic way. A user interface may be provided for creating and editing deployment jobs, and providing the deployment jobs to the client devices through customized plug-in modules at the administrative systems. An API (application programming interface) may be provided for extending device management solutions for managing client devices through proprietary administrative systems. For instance, a scrip table interface may be provided (e.g., called from a script or shell) for creating and editing the deployment jobs. Still furthermore, techniques are provided for signaling the desired actions of proprietary plug-ins, and for acquiring and persisting the state of the deployment jobs. Furthermore, a management system may store and retrieve settings on behalf of the administrative systems before and/or after deployment jobs (e.g., imaging) are performed. This may enable state persistence across “sessions” of imaging and/or other management related tasks.

Embodiments enable a device manufacturer (OEM) to extend the capabilities of a configuration management system (e.g., a configuration platform or tool), such as Configuration Manager developed by Microsoft Corporation of Redmond, Wash. Embodiments enable the configuration management system to manage client devices, including imaging the client devices.

Example embodiments of the present invention are described in the following subsections. Such example embodiments are not intended to be limiting. For instance, although embodiments are described as follows with regards to imaging being performed at client devices by client management devices via administrative systems, in other embodiments, additional and/or alternative types of actions may be performed at the client devices. Further embodiments, including modifications and/or combinations of the embodiments described, herein, will be apparent to persons skilled in the relevant art(s) from the teachings herein.

A. Example Device Management Embodiments

Embodiments may be configured in various ways to manage devices. For instance, FIG. 1 shows a block diagram of a configuration management environment 100, according to an example embodiment. Embodiments for managing devices may be implemented in environments such as environment 100 or in other environments. As shown in FIG. 1, environment 100 includes a configuration management system 102, a client administration system 104, a client device 106, and a network 108. Environment 100 is described as follows.

Configuration management system 102 may be any type and/or configuration of one or more devices configured to manage one or more client devices, such as client device 106. For instance, configuration management system 102 may include one or more computing devices (e.g., computers, servers, etc.), and may be commercially available or special purpose. Configuration management system 102 is capable of performing particular administrative tasks on client devices through intermediate administrative systems, including managing client device 106 through client administrative system 104.

Client administration system 104 is configured to directly administer one or more client devices, such as client device 106. For example, client administrative system 104 is coupled to client device 106 by a communication link 118, and may perform administrative tasks with respect to client device 106 using communications over communication link 118, including modifying operational settings of client device 106, modifying a software configuration of client device 106 (e.g., downloading firmware/software to be stored in client device 106, erasing firmware/software stored in client device 106, etc.), and/or further types of administrative tasks. Client administration system 104 may be a proprietary device such as an OEM (original equipment manufacturer) deployment system that is configured specifically for administering one or more types of client devices, a computer system configured specifically for administering one or more types of client devices, or other device configured to administer client devices.

Client device 106 is a device that performs one or more functions. In an embodiment, client device 106 may be a general purpose computer, such as a thin client personal computer, a full client personal computer, a server, or an other type of computing device. In another embodiment, client device 106 may be an embedded device, such as a device that has an embedded operating system, but does not have the full features of a computer system. For instance, client device 106 may be a handheld terminal (HHT) (a handheld barcode/symbol scanner, a handheld RFID (radio frequency identification) reader, etc.), a medical device (e.g., a medical image-capturing device such as an MRI (magnetic resonance imaging) machine, etc.), a smart phone, an ATM (automatic teller machine), a general purpose personal computer, or other type of embedded device.

Configuration management system 102 and client administration system 104 are communicatively coupled by network 108. Network 108 may include one or more communication links and/or communication networks, such as a PAN (personal area network), a LAN (local area network), a WAN (wide area network), or a combination of networks, such as the Internet. Network 108 may include any number of communication links, including wired and/or wireless links, such as IEEE 802.11 wireless LAN (WLAN) wireless links, Worldwide Interoperability for Microwave Access (Wi-MAX) wireless personal area network (PAN) links (e.g., Bluetooth™ links), Ethernet links, USB links, etc.

Client administrative system 104 and client device 106 are communicatively coupled by communication link 118, which may include one or more networks (e.g., one or more LANs and/or WANs) the same as or similar to network 108, in some embodiments. For instance, communication link 118 may include one or more communication links, including wired and/or wireless links, such as an IEEE 802.11 WLAN wireless link, a Wi-MAX link, a PAN link, a LAN, a WAN, an Ethernet link, a USB link, a proprietary communication link, etc.

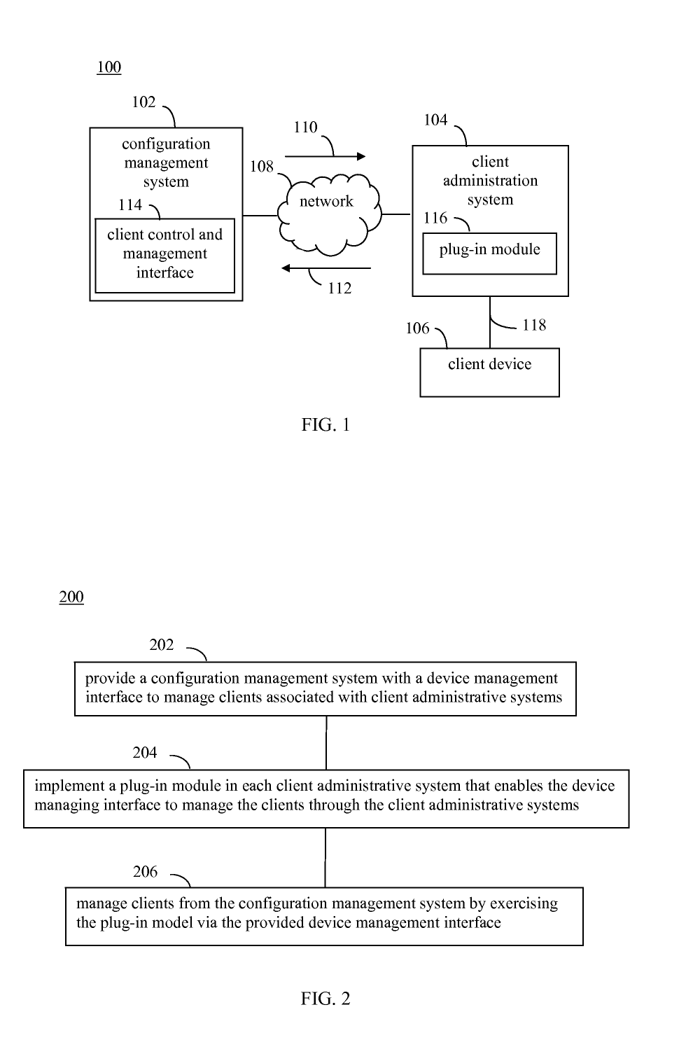

According to embodiments, configuration management system 102 is configured to perform one or more types of management tasks device imaging) on client devices, such as client device 106, through one or more client device-type specific client administration systems, such as client administration system 104 (e.g., client administration system 104 is specifically configured to administer devices of the type of client device 106). As such, configuration management system 102 enables a single point of control and management of client devices through various types of client administration systems, which may each have a different configuration for managing their respective client devices. Configuration management system 102 enables management of the different client devices through a uniform interface. For instance, FIG. 2 shows a flowchart 200 providing a process for managing client devices, according to an example embodiment. Further structural and operational embodiments will be apparent to persons skilled in the relevant art(s) based on the discussion regarding flowchart 200. Flowchart 200 is described as follows with reference to environment 100 of FIG. 1.

Flowchart 200 begins with step 202. In step 202, a configuration management system is provided with a device management interface to manage clients associated with client administrative systems. For instance, as shown in FIG. 1, configuration management system 102 includes a client control and management interface 114. In an embodiment, client control and management interface 114 may be implemented in configuration management system 102 to provide an interface for communicating with and managing client devices (e.g., client device 106) through client administration systems (e.g., client administration system 104). For example, interface 114 may implement a public API (application programming interface) to enable imaging and/or other management functions for a set of client devices through one or more client administration systems. In an embodiment, interface 114 may include a user interface that enables a user (e.g., a device administrator, an IT (information technology) professional, etc.) to perform command and control of the extended functionality. The user interface may be a graphic user interface such as a wizard, or may be a command line interface or script. Interface 114 may provide a service for starting up, shutting down, tracking, and storing of deployment jobs that are in progress, including enabling a status of individual client devices to be provided.

For example, as shown in FIG. 1, interface 114 may transmit a deployment job 110 to client administrative system 104. Deployment job 110 includes one or more management tasks (e.g., imaging tasks, etc.) to be performed on client device 106 through client administrative system 104.

In step 204, a plug-in module is implemented in each client administrative system that enables the device managing interface to manage the clients through the client administrative systems. For instance, as shown in FIG. 1, client administration system 104 includes a plug-in module 116. Plug-in module 116 provides an interface for client administration system 104 for communications with interface 114 of configuration management system 102, enabling configuration management system 102 to provide deployment jobs to client administration system 104 to be implemented on client device 106. For instance, in one embodiment, client administration system 104 implements plug-in module 116 to client control and management interface 114 (e.g., which may be an API) of client management system 102. In an embodiment, plug-in module 116 may be provided in a standard form to an administrator, and customized by the administrator for integration in client administrative system 104. Plug-in module 116 may provide one or more standard interfaces for communications with interface 114 of configuration management system 102. As a result, through the user interface provided, by interface 114 of configuration management system 102, client device 106 and further client devices in environment 100 may be managed using a “single pane of glass.”

In step 206, clients are managed from the configuration management system by exercising the plug-in model via the provided device management interface. For example, as shown in FIG. 1, plug-in module 116 of client administrative system 104 may receive deployment job 110 from interface 114 of configuration management system 102. Plug-in module 116 enables the one or more management tasks of deployment job 110 to be performed on client device 106 (and potentially further client devices 106 associated with client administrative system 104). As shown in FIG. 1, plug-in module 116 may transmit a status indication 112 to interface 114. Plug-in module 116 may receive status information from client device 106 (and potentially further client devices 106) regarding the progress of the one or more management tasks, and may include the status information in status indication 112 transmitted to interface 114.

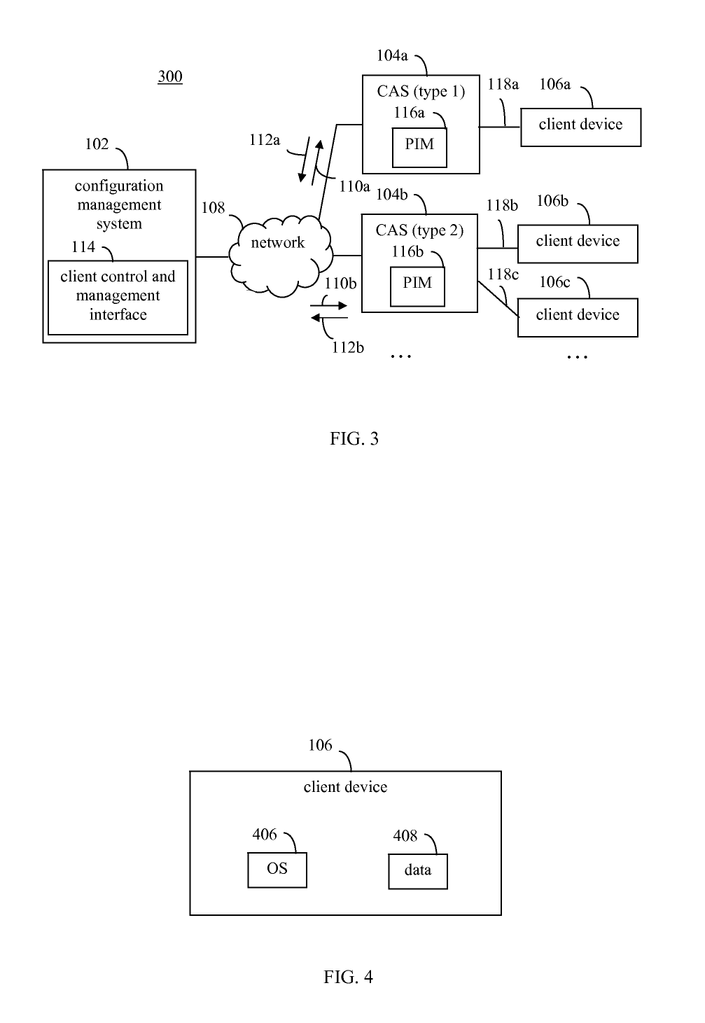

Any number of client devices may he managed through any number of client administrative systems by configuration management system 102. For instance, FIG. 3 shows a block diagram of a configuration management environment 300 that includes multiple client administration systems 104 and client devices 106 managed by configuration management system 102, according to an example embodiment. As shown in FIG. 3, first and second client administrative systems (CASs) 104a and 104b are present, and are different types of administrative systems (e.g., CAS 104a is indicated as type 1, corresponding to a first type of administrative system, CAS 104b is indicated as type 2, corresponding to a second type of administrative system, etc.). Because they are different, CASs 104a and 104b are configured to administer different types and/or configurations of client devices, are provided by different manufacturers, etc. First and second CASs 104a and 104b are shown for illustrative purposes, and any number of further CASs 104 may be present, in embodiments. Furthermore, as shown FIG. 3, first and second CASs 104a and 104b each include a respective one of first and second plug-in modules (PIMs) 116a and 116b. PIM 116a is customized for CAS 104a (e.g., for client devices of type 1) to enable communications with interface 114 of configuration management system 102, and PIM 116b is customized for CAS 104b (e.g., for client devices of type 2) to enable communications with interface 114 of configuration management system 102,

Still further, CAS 104a is communicatively coupled with client device 106a through communication link 118a, and CAS 104b is communicatively coupled with client device 106b through communication link 118b and with client device 106c through communication link 118c. It is noted that each of CAS 104a and 104b may be coupled with any number of client devices 106, although one client device 106a and two client devices 106b and 106b are respectively shown in FIG. 3 for ease of illustration. Furthermore, each client device 106 may be coupled with any number of CASs 104, including multiple CASs 104.

As such, in environment 300, configuration management system 102 is enabled by interface 114 and PIM 116a to manage client device 106a, and is enabled by interface 114 and PIM 116b to manage client devices 106b and 106c. For instance, a user may interact with a common user interface provided by interface 114 to manage client devices 106a-106c. A variety of management tasks may be performed via interface 114, including imaging client devices, disabling/enabling client devices, etc. For instance, FIG. 4 shows a block diagram of an example client device 106. As shown in FIG. 4, client 106 includes an operating system (OS) 406 and data 408. OS 406 is an operating system that manages resources of client device 106. Data 408 may be configuration data or other types of data associated with client device 106. In an embodiment, client control and management interface 114 may enable one or more imaging related-tasks to be performed with respect to client device 106 of FIG. 4, including one or more of deleting OS 406 from storage, partially or entirely deleting data (e,g., erasing data 408 from memory/storage), installing an operating system in client device 106 (e.g., performing the initial install of OS 406, or installing a another OS to replace OS 406—“re-imaging” client device 106), installing an application/software update or patch in client device 106, updating a BIOS (basic input/output system) in client device 106, performing a third-party compliance verification, performing anti-virus and/or security scanning, etc. Interface 114 may enable such imaging-related tasks to be performed on any number of client devices 106, including client devices 106a-106c in FIG. 3, through any number of CASs 104.

Note that client device 106 may include any type of storage and/or memory that contain OS 406 and data 408. Examples of such storage/memory include a storage device/medium such as a hard disk drive, permanent memory, volatile memory, and/or non-volatile memory. One or more types of memory devices may be present, such as random access memory (RAMs), read only memory (ROM), flash memory, etc.

B. Example Device Imaging Embodiments

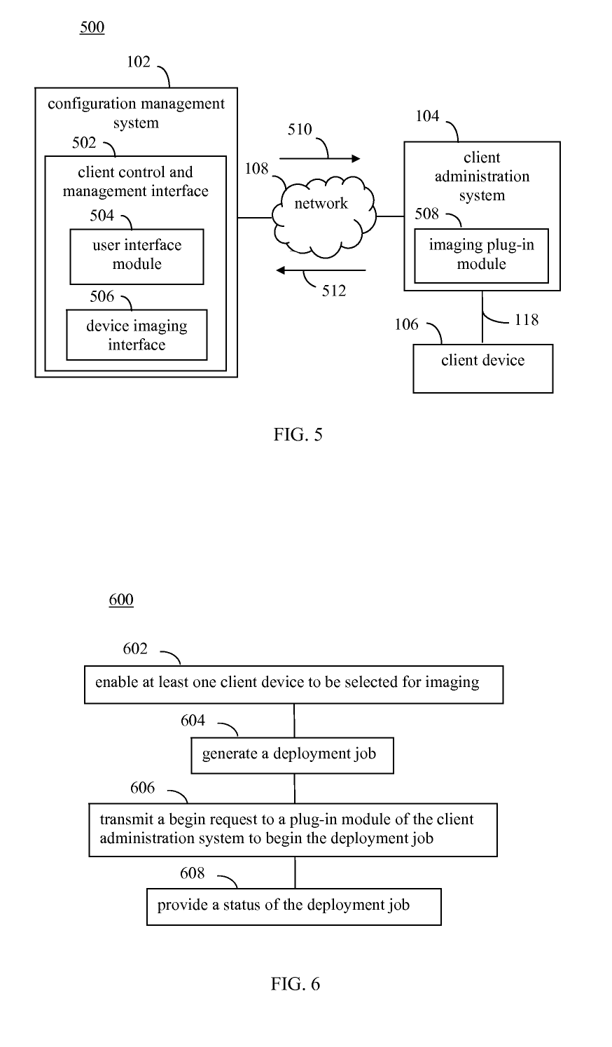

In embodiments, client control and management interface 114 of client management system 102 may be configured in various ways to manage various aspects of client devices through CASs. For instance, FIG. 5 shows a block diagram of a configuration management environment 500, according to an example embodiment. As shown in FIG. 5, environment 500 includes configuration management system 102, client administration system 104, client device 106, and network 108. Furthermore, configuration management system 102 includes a client control and management interface 502, which is an example of interface 114 of FIG. 1 that is configured for the imaging of client devices. As shown in FIG. 5, client control and management interface 502 includes a user interface module 504 and a device imaging interface 506. Still further, CAS 104 includes an imaging PIM 508. Imaging PIM 508 is an example of PIM 116 that is configured to perform imaging tasks on client devices under the control of client control and management interface 502.

For example, in an embodiment, user interface module 504 may generate a user interface with which a user may interact to configure an imaging deployment job, to modify an existing imaging deployment job, to analyze a status of a deployment job in progress, and/or to otherwise manage an imaging deployment job. Device imaging interface 506 is configured to generate and/or modify imaging deployment jobs according to the user interactions with the user interface generated by user interface module 504. Furthermore, device imaging interface 506 performs communications with imaging PIM 508 at CAS 104, including generating imaging deployment jobs, transmitting the imaging deployment jobs to imaging PIM 508, and receiving status information from imaging PIM 508. The user interface generated by user interface module 504 enables the status information received by device imaging interface 506 to be provided to the user.

Client control and management interface 502 may perform its functions in various ways. For instance, FIG. 6 shows a flowchart 600 providing a process for imaging client devices, according to an example embodiment. Flowchart 600 may be performed by client control and management interface 502, in an embodiment. Further structural and operational embodiments will be apparent to persons skilled in the relevant art(s) based On the discussion regarding flowchart 600. For illustrative purposes, flowchart 600 is described as follows with respect to FIG. 5.

Flowchart 600 begins with step 602. In step 602, at least one client device is enabled to be selected for imaging. For example, user interface module 504 in FIG. 5 may generate a user interface that enables a user to select one or more client devices associated with one or more CASs associated with configuration management system 102 for imaging. The user interface may be a graphical user interface (GUI) that includes one or more windows or forms having graphical elements that enable one or more clients to be selected. Alternatively, the user interface may be a command line interface, a scripting interface, or other type of interface. The user interface may further enable an image file (e.g., for an operating system, an application, and/or other program or data) to be selected to be loaded onto the selected client device(s) during the imaging, and may enable further parameters associated with the imaging to be selected., including an imaging schedule, etc.

In step 604, a deployment job is generated. For instance, as shown in FIG. 5, device imaging interface 506 may generate an imaging deployment job that indicates the client device(s) selected for imaging input by a user at the user interface generated by user interface module 504. To generate an imaging deployment job, device imaging interface 506 may generate a deployment job identifier for the imaging deployment job that may be used to identify and track the deployment job. Device imaging interface 506 may store the deployment job in the form of a file, as one or more entries in a database (e.g., in the form of properties), or in other form in storage, including any type of storage or memory mentioned elsewhere herein or otherwise known. Device imaging interface 506 may include further information in the imaging deployment job, including an indication of the selected image file for the deployment job, the selected imaging schedule, and/or other information.

In step 606, a begin request is transmitted to a plug-in module of the client administration system to begin the deployment job. For example, as shown in FIG. 5, device imaging interface 506 transmits a deployment job begin request 510. Begin request 510 is a request to imaging plug-in module 508 to being imaging one or more client devices, such as client device 106, according to the deployment job generated in step 604. As shown in FIG. 6, begin request 510 is transmitted through network 108, and is received by imaging PIM 508. Imaging PIM 508 may request further information from device imaging interface 506 regarding the deployment job prior to beginning imaging. Alternatively, begin request 510 may include all the information needed by imaging PIM 508 to begin imaging. Once the information needed for imaging is received, PIM 508 may begin imaging the indicated client device(s) 106. PIM 508 may communicate with client device 106 over communication link 118 to perform the imaging of client device 106, if multiple client devices 106 are to be imaged, PIM 508 may perform the imaging of the multiple client devices 106 serially or in parallel. In another embodiment, the task of imaging multiple client devices 106 may be delegated to a group of distributed downstream CASs 104 that may divide the client devices between them, and perform the imaging of their respective client devices 106 (using respective PIMs 508) in serial or parallel.

In step 608, a status of the deployment job is provided. For example, in an embodiment, device imaging interface 506 may transmit a status request to imaging PIM 508, imaging PIM 508 may determine a status of the progress of the imaging of the client device(s), and may transmit the determined status in response. Alternatively, imaging PIM 508 may periodically determine a status of the progress of the imaging of the client device(s), and may transmit the determined status to device imaging interface 506. As shown in FIG. 5, imaging PIM 508 transmits status indication 512 through network 108 to device imaging interface 506. Device imaging interface 506 receives status indication 512, and may provide (e.g., display) a status of the imaging as indicated by status indication 512.

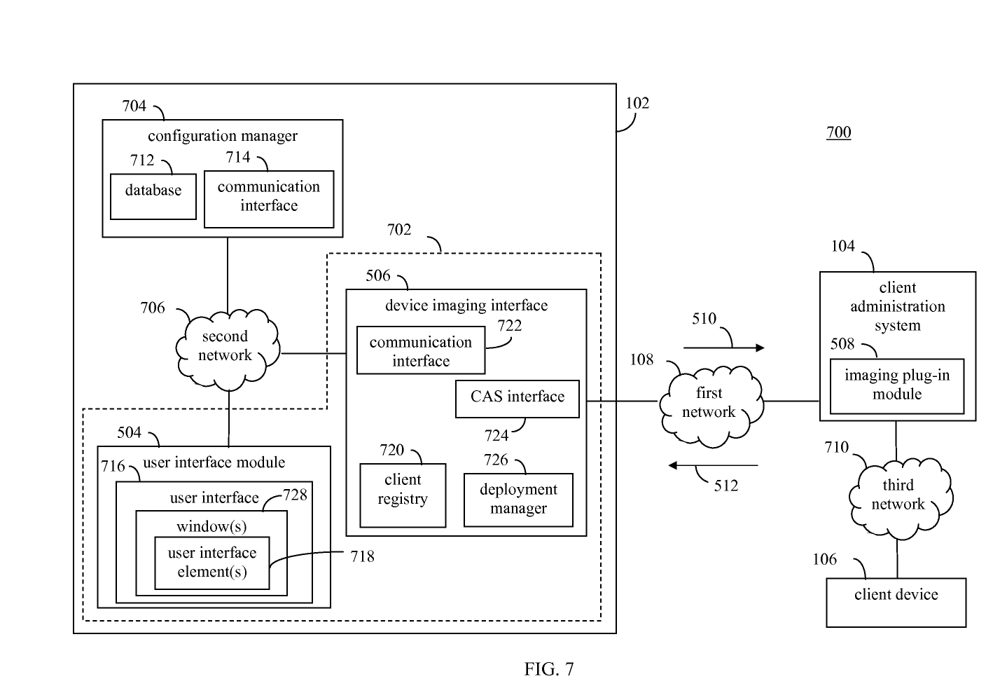

In embodiments, client management system 102 of FIG. 5 may be configured in various ways to image client devices through CASs. For instance, FIG. 7 shows a block diagram of a configuration management environment 700, according to an example embodiment. As shown in FIG. 7, environment 700 includes configuration management system 102, client administration system 104, client device 106, and network 108. Furthermore, configuration management system 102 includes a configuration manager 704 and a client control and management interface 702, which is an example of interface 502 of FIG. 5. As shown in FIG. 7, configuration manager 704 includes a database 712 and a communication interface 714, and client control and management interface 702 includes user interface module 504 and device imaging interface 506. Still further, user interface module 504 generates a user interface 716 that includes one or more windows 728 that include one or more user interface elements 718. Device imaging interface 506 includes a client registry 720, a communication interface 722, a CAS interface 724, and a deployment manager 726. CAS 104 includes imaging PIM 508. Environment 700 is further described as follows.

Configuration manager 704 provides configuration management functionality to configuration management system 102. For instance, configuration manager 704 may be a commercially available or proprietary configuration manager, such as Configuration Manager developed by Microsoft Corporation, or other configuration manager that is configured to assess, deploy, and update servers, client computers, and other devices, and to maintain the consistency of software across the devices. Client control and management interface 702 may be included in configuration management system 102 to extend configuration manager 704 to enable imaging of diverse client devices, as described above. Configuration manager 704 may be implemented in a computer system, such as a personal computer or server, or in other device. In an embodiment, client control and management interface 702 may be included in a same computer system or device as configuration manager 704, although this is not required.

Database 712 of configuration manager 704 stores information about devices associated with configuration manager 704. For instance, database 712 may store information about client device 106 and further client devices, including client device identifiers, network addresses, device configurations, device capabilities, and/or further information. Database 712 may have any format, including being an SQL (structured query language) database, or other type of database.

Communication interface 714 enables configuration manager 704 to communicate with user interface module 504 and device imaging interface 506 (through communication interface 722) over second network 706. Second network 706 and first network 108 may be the same network or different networks. Second network 706 may include any type of network and/or communication link described herein, or otherwise known, and may support any suitable communication protocols. In one example embodiment, communications over second network 706 may be performed according to a WMI (windows management instrumentation) protocol. For instance, communication interfaces 714 and 722 may each include one or more WMI providers configured to enable communications according to the WMI protocol. In other embodiments, communication interfaces 711 and 722 may communicate according to other techniques and/or protocols.

User interface module 504 may generate user interface 716 to have any desired form, in embodiments. For instance, user interface 716 may include one or more forms or windows 728 that include one or more of any type of user interface element(s) 718 to receive data from a user. For instance, in one embodiment, user interface module 504 may generate user interface 716 as a “wizard,” having multiple windows that are displayed sequentially, one after another, to lead the user through a series of steps. After the user fills in the requested information in a window, a “next” button or other user interface element may be selected, and a next window may be provided that requests further information to be filled in by the user. This may be repeated until all desired information is collected, and the information is submitted (e.g., by a “finish” button, etc.). In this manner, user interface 716 may enable the user to configure a new imaging deployment job, or to modify an already existing imaging deployment job. In other embodiments, user interface 716 may have other forms to collect the desired information from the user. User interface 716 may include any number and combination of user interface elements 718, such as text entry blanks, radio buttons, pull down menus, etc., which the user may interact with using a keyboard, a thumb wheel, a pointing device, a roller ball, a stick pointer, a touch sensitive display, any number of virtual interface elements, a haptic interface, a voice recognition system, and/or other user interface elements described elsewhere herein or otherwise known.

CAS interface 724 of device imaging interface 506 enables communications with one or more imaging PIMs 508 at one or more CASs 104 over network 108. CAS interface 724 may be any type of communication interface, wired or wireless, that communicates according to any suitable protocol, such as an as IEEE 802.11 wireless LAN (WLAN) wireless interface, a Worldwide Interoperability for Microwave Access (Wi-MAX) interface, an Ethernet interface, a Universal Serial Bus (USB) interface, etc. For example, in an embodiment, CAS interface 724 may be a DCOM (distributed component object model) client. In other embodiments, CAS interface 724 may communicate according to other techniques and/or protocols.

Client registry 720 of device imaging interface 506 enables plug-in modules to register with device imaging interface 506 in order to be used to image their respective client devices. For example, PIM 508 may register with client registry 720 by providing an address and/or path for PIM 508 (e.g., a COM DLL (dynamic link library), etc.), an identifier or key for PIM 508, a plain text name for PIM 508, a branding image for PIM 508, etc. Furthermore, identifiers and farther information regarding the client devices associated with PIM 508 may optionally be included in the registration for PIM 508 in client registry 720.

Deployment manager 726 is configured to manage/control interactions between device imaging interface 506 and imaging PIM 508. For instance, deployment manager 726 may generate deployment jobs (e.g., as described above for step 604 of flowchart 600 in FIG. 6), and may manage a sequence of communications with imaging PIM 508 to begin imaging client devices as described above for step 604 of flowchart 600), to pause, resume, and/or select termination of the imaging of client devices, to receive status information about imaging being performed by imaging PIM 508 (e.g., as described above for step 606 of flowchart 600), and/or to perform further imaging related functions. For example, deployment manager 726 may be implemented in the form of logic, a state machine, and/or other form.

Various example embodiments for the features of FIG. 7 are described in further detail in the following subsections. Note that although the example embodiments are described with reference to device imaging, such embodiments may also be applied to other types of device managing tasks.

1. Example User Interface Embodiments

User interface module 504 may generate user interface 506 and user interface 504 may be interacted with by users in various ways. For example, as described above, user interface module 504 may generate user interface 716 to have any number of windows and/or user interface elements to enable users to configure any number of characteristics or properties for one or more imaging deployment jobs.

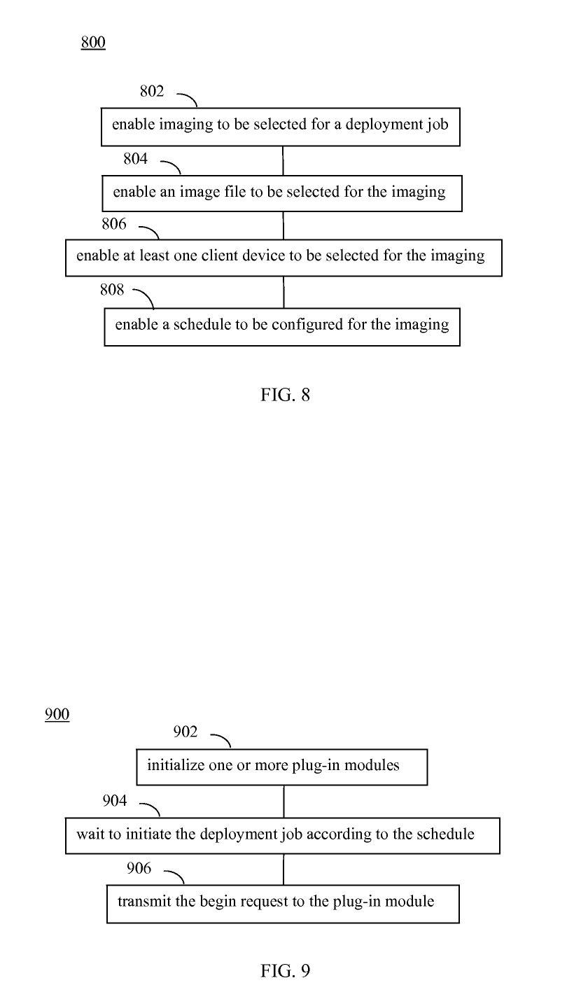

For instance, FIG. 8 shows a flowchart 801) providing a process for imaging client devices, according to an example embodiment. Flowchart 800 may be performed by user interface module 504, in an embodiment. Further structural and operational embodiments will be apparent to persons skilled in the relevant art(s) based on the discussion regarding flowchart 800. Note that not all of the steps of flowchart 800 need to be performed in all embodiments, and in some embodiments, the steps may be performed in different orders than shown in FIG. 8. For illustrative purposes, flowchart 800 is described as follows with reference to FIG. 7.

Flowchart 800 begins with step 802. In step 802, imaging is enabled to be selected for a deployment job. For example, in an embodiment, user interface module 504 may generate user interface 716 to provide a user interface element that enables a user to select imaging to be performed. For example, a window of user interface 716 may provide a pull-down or pop-up menu, or other user interface element that enables a user to select an imaging function.

In step 804, an image file is enabled to be selected for the imaging. For example, in an embodiment, user interface module 504 may generate user interface 716 to provide a user interface element that enables a user to select an image file to be selected. The image file is selected to be loaded onto one or more client devices to perform the imaging. The image file may include one or more files representative of an operating system, an application, data, or other information to be loaded onto the one or more client devices. For example, a window of user interface 716 may provide a pull-down or pop-up menu, a text entry blank, or other user interface element that enables a user to select an image file (e.g., by navigating/browsing to the file in a directory structure in storage, etc.). Imaging files that may be selected may be stored in any type of storage mentioned. elsewhere herein or otherwise known, and may be stored in database 712 (of configuration manager 712), in storage of device imaging interface 506, or elsewhere.

In step 806, at least one client device is enabled to be selected for the imaging. For example, in an embodiment, user interface module 504 may generate user interface 716 to provide a user interface element that enables a user to select one or more client devices on which the imaging is to be performed (e.g., where the image file is to be loaded). For example, a window of user interface 716 may provide a pull-down or pop-up menu, a text entry blank, or other user interface element that enables a user to select one or more client devices. Client devices may be selected individually and/or in predetermined groups or collections. Information of the client devices that may be selected may be stored in any type of storage mentioned elsewhere herein or otherwise known, and may be stored in database 712 (of configuration manager 712), in storage of device imaging interface 506, or elsewhere.

In step 808, a schedule is enabled to be configured for the imaging. For example, in an embodiment, user interface module 504 may generate user interface 716 to provide a user interface element that enables a user to select a schedule for performing the imaging on the selected client device(s) (e.g., when the image file is to be loaded). For example, the user may be enabled to select a time and date on which the imaging is to be performed, may select a window of time (having a start time/date and an end/expiration time/date) during which the imaging may be performed, and/or may be enabled to select other tune frame for performing the imaging. For example, a window of user interface 716 may provide one or more text entry blanks, a calendar tool, or other user interface element that enables a user to schedule the imaging. Client devices may be selected to be imaged according to a same schedule or according to different schedules.

After the desired characteristics/properties of an imaging task are submitted into user interface 716, a “submit” or “finish” button, or other suitable user interface element, may be interacted with (e.g., selected or clicked on) to submit the imaging task as an imaging deployment job. In an embodiment, the imaging deployment job may be processed and saved by device imaging interface 506, as described in the next subsection, or may be saved in other manner. For instance, the information input by the user through user interface 716 may be transmitted to device imaging interface 506 to be received through communication interface 722, and may be stored by deployment manager 726 in storage associated with device imaging interface 506 as an imaging deployment job.

In embodiments, user interface module 504 may generate user interface 716 to provide user interface elements to select/designate additional and/or alternative properties/characteristics of an imaging task. For example, user interface module 504 may generate user interface 716 to provide one or more user interface elements to enable a user submit a name (e,g., a textual name) for the imaging deployment job, to submit a description (e.g., a textual description) for the imaging deployment job, and/or other information.

As described above, user interface 716 may include a single window, or may include a sequence of windows (e.g., a wizard) for receiving properties/characteristics of an imaging task. In one example of a multi--window embodiment, a first window may be a “General” window for receiving the information of steps 802, 804, and 806, a second window may be a “Schedule” window for receiving the information of step 808, and a third window may be a “Summary” window that shows the properties for the deployment job. A fourth window may be a “Progress” window that is used to display status information on the progress of a deployment job, as described elsewhere herein. Furthermore, a fifth window may be a “confirmation” window that is used to confirm and enter the submitted information for a deployment job.

Furthermore, user interface module 504 may generate user interface 716 to provide one or more user interface elements to enable a user to modify characteristics of a previously submitted imaging deployment job. For example, in an embodiment, user interface module 504 may generate user interface 716 to provide user interface element that enables a user to select a previously submitted imaging deployment job. The selected imaging deployment job may be opened in one or more windows that display characteristics/properties of the imaging deployment job, and that enable the characteristics/properties to be modified as desired. The modified imaging deployment job may subsequently be submitted.

Still further, user interface module 504 may generate user interface 716 to provide one or more user interface elements to enable deployment jobs that are currently operating to be paused, resumed, terminated, and/or otherwise modified. Examples of such modifications to operating deployment jobs are further described below.

2. Example Device Imaging Interface Embodiments

Device imaging interface 506 may be configured to interface with plug-in modules in various ways. For instance, FIG. 9 shows a flowchart 900 providing a process for imaging client devices, according to an example embodiment. Flowchart 900 may be performed by device imaging interface 506, in an embodiment. Further structural and operational embodiments will be apparent to persons skilled in the relevant art(s) based on the discussion regarding flowchart 900. Note that not all of the steps of flowchart 900 need to be performed in all embodiments, and in some embodiments, the steps may be performed in different orders than shown in FIG. 9. For illustrative purposes, flowchart 900 is described as follows with reference to FIG. 7.

Flowchart 900 begins with step 902. In step 902, one or more plug-in modules is/are initialized. In an embodiment, deployment manager 726 of device imaging interface 506 may be configured to initialize one or more of the PIMs associated with device imaging interface 506 at various times. For instance, deployment manager 726 may initialize PIMs at power-up or when deployment manager 726 is executed, at periodic intervals, and/or at other times. For instance, in an embodiment, deployment manager 726 may access client registry 720 to identify any PIMs registered with device imaging interface 506, and may instruct/enable CAS interface 724 to transmit one or more initialization signals over network 108 to one or more associated. CASs 104 to initialize the registered PIMs 508. Upon receiving an initialization signal, a PIM 508 may perform any number of suitable initialization functions, including determining and providing a status of one or more client devices 106 associated with the PIM 508, etc.

In step 904, the deployment job is initiated after waiting according to the schedule. Step 904 is optional. In an embodiment, deployment manager 726 may access storage associated with device imaging interface 506 for submitted deployment jobs. One or more of the submitted deployment jobs may indicate an associated schedule (e.g., as described above for step 808 of flowchart 800 in FIG. 8). For any deployment job having an associated schedule, deployment manager 726 may wait until the start of the time frame defined by the schedule before initiating the deployment job (according to step 906, as follows).

In step 906, the begin request is transmitted to the plug-in module. For example, similarly to step 606 of flowchart 600 (FIG. 6), as shown in FIG. 7, deployment manager 726 may instruct/enable CAS interface 724 to transmit deployment job begin request 510 to request imaging PIM 508 to being imaging one or more client devices, such as client device 106, according to the associated deployment job. As shown in FIG. 6, begin request 510 is transmitted through network 108, and is received by imaging PIM 508. Imaging PIM 508 may request further information from deployment manager 726 (through CAS interface 724) regarding the deployment job prior to beginning imaging, or begin request 510 may include all the information needed by imaging PIM 508 to begin imaging. Once all the information needed for imaging is received. PIM 508 may begin imaging the indicated client device(s) 106. PIM 508 may communicate with client device 106 over communication link 118 to perform the imaging of client device 106. If multiple client devices 106 are to be imaged, PIM 508 may perform the imaging of the client devices 106 serially or in parallel.

3. Example Plug-In Module Embodiments

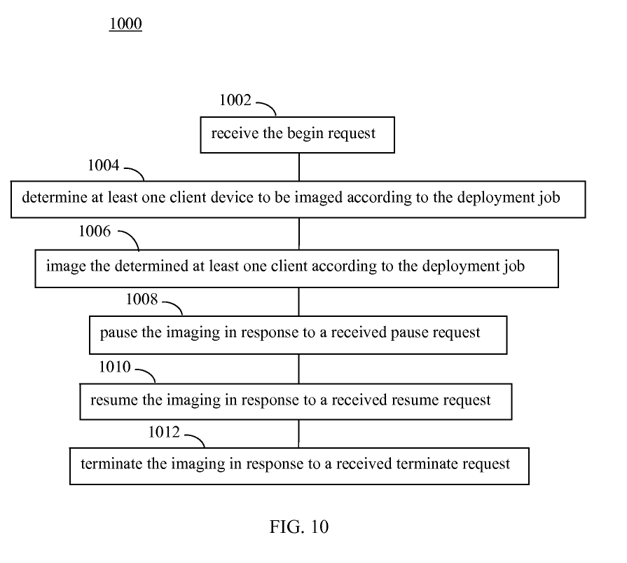

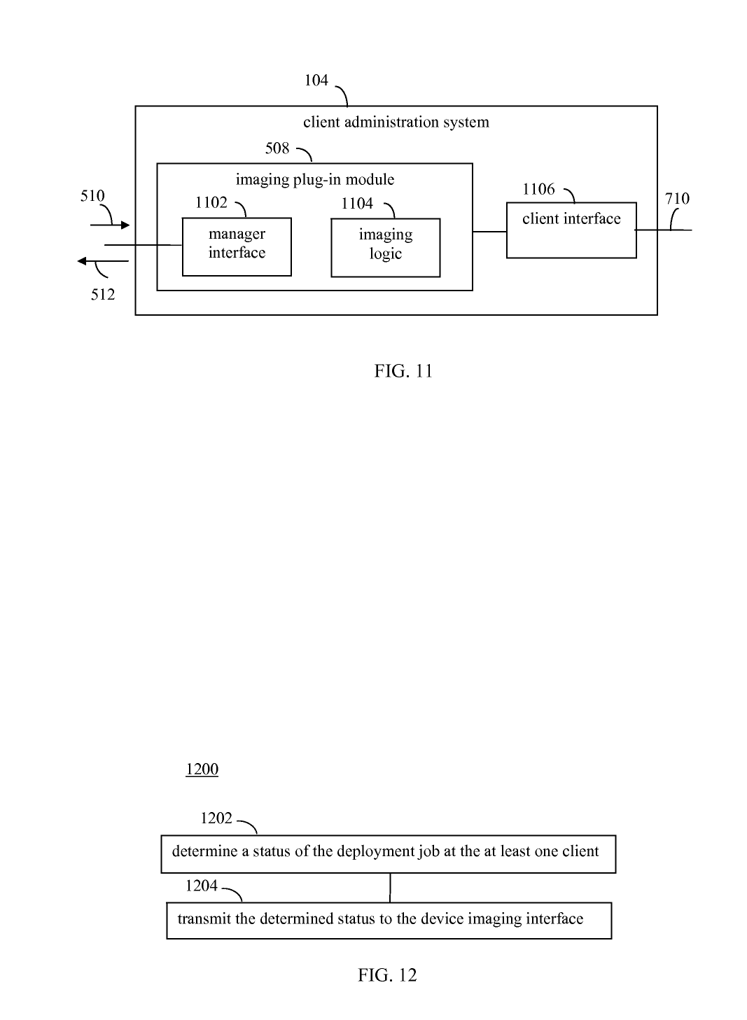

Plug-in modules, such as imaging PIM 508 in FIG. 7, may be configured to perform imaging of client devices in various ways. For instance, FIG. 10 shows a flowchart 1000 providing a process for imaging client devices, according to an example embodiment. Flowchart 1000 may be performed by imaging PIM 508, in an embodiment. Further structural and operational embodiments will be apparent to persons skilled in the relevant art(s) based on the discussion regarding flowchart 1000. For instance, FIG. 11 shows a block diagram of CAS 104, according to an example embodiment. As shown in FIG. 11, CAS 104 includes imaging PIM 508 and client interface 1106, and imaging PIM 508 includes a manager interface 1102 and imaging logic 1104. Client interface 1106 is a communication interface of CAS 104 that enables CAS 104 to communicate with client devices over network 710. Client interface 1106 may be any type of communication interface described herein or otherwise known, and may be proprietary or commercially available. Manager interface 1102 is a communication interface of imaging PIM 508 that enables imaging PIM 508 to communicate with CAS interface 724 over network 108. Manager interface 1102 may be configured to communicate according to any suitable communication protocol mentioned elsewhere herein or otherwise known (e.g., DCOM). Imaging logic 1104 is configured to manage the imaging of client devices according to requests/instructions received from deployment manager 726 of FIG. 7. Imaging logic 1104 may be implemented in any suitable manner to perform its functions, including in the form of software and/or firmware that may be executed in one or more processors,

Note that not all of the steps of flowchart 1000 need to be performed in all embodiments, and in some embodiments, the steps may be performed in different orders than shown in FIG. 10. For illustrative purposes, flowchart 1000 is described as follows with reference to FIG. 7 and FIG. 11.

Flowchart 1000 begins with step 1002. In step 1002, the begin request is received. In an embodiment, imaging PIM 508 of FIGS. 7 and 11 may wait for a begin request prior to imaging any client devices. Begin request 510 may be transmitted to imaging PIM 508 by CAS interface 724 over network 108. As shown in FIG. 11, begin request 510 may be received by imaging PIM 508 by manager interface 1102,

In step 1004, at least one client device is determined for imaging according to the deployment job. In one embodiment, begin request 510 may indicate one or more client devices, such as client devices 106, that are to be imaged according to the associated imaging deployment job, and may indicate the image file to be used for the imaging. In an embodiment, imaging logic 1104 may be configured to determine the one or more client devices and/or or imaging file from begin request 510. In such an embodiment, imaging logic 1104 may be able to initiate imaging without further communications with device imaging interface 506. In another embodiment, begin request 510 may provide an identifier for the deployment job to be begun, but may not indicate any client devices for imaging and/or may not indicate the image file to be used. In such case, imaging logic 1104 may need to conduct one or more additional communications with device imaging interface 506 prior to initiating imaging,

For instance, in response to begin request 510, imaging logic 1104 may instruct/enable manager interface 1102 to transmit a request to CAS interface 724 that includes the imaging deployment job identifier. The request may be a request to identify one or more client devices associated with PIM 508 to be imaged according to the imaging deployment job. Deployment manager 726 may determine the one or more client devices associated with the identified deployment job, and may instruct/enable CAS interface 724 to transmit a response to imaging PIM 508 that identifies the one or more client devices, including client device 106, to be imaged. Manager interface 1102 may receive the response. Furthermore, the response may indicate the image file (e.g., may include the image, or may provide a pointer to the location of the image file) to be used for the imaging, or imaging logic 1104 may instruct/enable manager interface 1102 to transmit a subsequent request to CAS interface 724 to have deployment manager 726 provide an indication of the image file.

In step 1006, the determined at least one client is imaged according to the deployment job. In an embodiment, imaging logic 1104 may image client device 106 and/or any other associated client devices identified in step 1006. As described above, imaging logic 1104 may delete an operating system and/or other software/firmware from client device 106, may partially or entirely clear memory of client device 106, may install an operating system in client device 106, may install a software update or patch in client device 106, and/or may perform other imaging task with regard to client device 106 (and any further identified client devices). The imaging may be performed in any manner by imaging logic 1104, including by using/controlling resources of CAS 104 to perform the imaging over communication link 118 in a proprietary or other manner.

For example, imaging logic 1104 of PIM 508 may image a plurality of client devices in a serial fashion as follows. The status of each client device may be set to “not yet imaged” or “not started.” Imaging logic 1104 may select a first client device for imaging. Imaging logic 1104 may attempt to image the client device, such as by deleting existing software/firmware at the client device and loading new software/firmware to the client device. If the imaging is successful, a status of the imaging at the client device is set to successful. If the imaging is not successful, it is determined whether to retry the imaging. If the imaging is retried, the status of the imaging at the client device is set to retrying, and if the imaging is not retried, the status of the imaging at the client device is set to failed. If a stop event (e.g., a pause or terminate request) is received by Imaging logic 1104 through manager interface 1102 at this point, imaging at the client device is completed, whether it is successful or failed, and no new client devices begin executing imaging logic/procedures (e.g., at least until a resume request is received). If a stop event was not received at this point, imaging logic 1104 determines whether a next client device is available to be imaged, and if so, attempts to image the client device as described at the beginning of this process. If no more client devices are available to be imaged, the imaging deployment job is finished. Note that in an alternative embodiment, imaging logic 1104 may image multiple client devices in a similar fashion in parallel.

In step 1008, the imaging is paused in response to a received pause request. For example, as described above, in an embodiment, user interface module 504 may generate user interface 716 to provide a user interface element that enables a user to pause a deployment job. In such case, deployment manager 726 may receive an indication of the pause request from user interface module 501 through second network 706 and communication interface 722. Deployment manager 726 may instruct/enable CAS interface 724 to transmit the pause request over network 108 to imaging logic 1104 (through manager interface 1102). Imaging logic 1104 may receive the pause request. Imaging logic 1104 may attempt to pause imaging at any client devices associated with the deployment job. In one embodiment, imaging logic 1104 may pause all client devices associated with the deployment job whether they have begun imaging or not, and have not already completed the imaging. In another embodiment, imaging logic 1104 may pause imaging for any client devices associated with the deployment job that have not begun imaging, while allowing any client devices that have already begun imaging to complete their imaging.

In step 1010, the imaging is resumed in response to a received resume request. For example, as described above, in an embodiment, user interface module 504 may generate user interface 716 to provide a user interface element that enables a user to resume a paused deployment job. In such case, deployment manager 726 may receive an indication of the resume request from user interface module 504 through second network 706 and communication interface 722. Deployment manager 726 may instruct/enable CAS interface 724 to transmit the resume request over network 108 to imaging logic 1104 (through manager interface 1102). Imaging logic 1104 may receive the, resume request. Imaging logic 1104 may attempt to resume any client devices associated with the deployment job that were paused.

In step 1012, the imaging is terminated in response to a received terminate request. For example, as described above, in an embodiment, user interface module 504 may generate user interface 716 to provide a user interface element that enables a user to terminate a deployment job. In such case, deployment manager 726 may receive an indication of the terminate request from user interface module 504 through second network 706 and communication interface 722. Deployment manager 726 may instruct/enable CAS interface 724 to transmit the terminate request over network 108 to imaging logic 1104 (through manager interface 1102). Imaging logic 1104 may receive the terminate request. Imaging logic 1104 may attempt to terminate imaging at any client devices associated with the deployment job. In one embodiment, imaging logic 1104 may terminate imaging at all client devices associated with the deployment job whether they have begun imaging or not, and have not already completed the imaging. In another embodiment, imaging logic 1104 may terminate imaging for any client devices associated with the deployment job that have not begun imaging, while allowing any client devices that already began imaging to complete their imaging. Note that in an embodiment, imaging logic 1104 may treat terminate requests in a similar manner as pause requests, although in other embodiments, they may be treated differently by imaging logic 1104 (e.g., imaging logic 1104 may not enable a “terminated” imaging to be resumed).

As described above a status or progress of imaging at client devices may be provided. Plug-in modules, such as imaging PIM 508 in FIG. 7, may be configured to report on the progress of the imaging of client devices in various ways. For instance, FIG. 12 shows a flowchart 1200 providing a status of the imaging of client devices, according to an example embodiment. Flowchart 1200 may be performed by imaging PIM 508, in an embodiment. Further structural and operational embodiments will be apparent to persons skilled in the relevant art(s) based on the discussion regarding flowchart 1200. For illustrative purposes, flowchart 1200 is described as follows with reference to FIG. 7.

Flowchart 1200 begins with step 1202. In step 1202, a status of the deployment job at the at least one client is determined. As described above, imaging logic 1104 of image PIM 508 may determine or keep track of a status of imaging at client devices, such as client device 106, such as “not yet started,” “successful”, “retrying”, or “failed.” Furthermore, imaging logic 1104 of PIM 508 may maintain an overall status of the deployment job, such as “not yet started, “in progress,” “paused,” “terminated,” or “finished.”

In step 1204, the determined status is transmitted to the device imaging interface. As such, periodically, or in response to a request by a user at user interface 716, imaging logic 1104 may instruct/enable manager interface 1102 to transmit the client device status and/or overall deployment job status as status indication 512 through network 108 to be received at CAS interface 724. Deployment manager 726 receives status indication 512, and deployment manager 726 may instruct/enable communication interface 722 to provide status indication 512 for display in user interface 716 by user interface module 504. Deployment manager 726 may provide additional status for the deployment job for display, including an indication that deployment manager 726 is waiting to begin the deployment job, the deployment job is started, the deployment job is suspended, the deployment job is terminated, or the deployment job is expired (e.g., the end date/time of the schedule passed).

### III. Example Computing Device Embodiments

Client control and management interface 114, plug-in module 116, client control and management interface 502, user interface module 504, device imaging interface 506, deployment manager 726, imaging logic 1104, and flowcharts 200, 600, 800, 900, 1000, and 1200 may be implemented in hardware, software, firmware, or any combination thereof. For example, client control and management interface 114, plug-in module 116, client control and management interface 502, user interface module 504, device imaging interface 506, deployment manager 726, imaging logic 1104, flowchart 200, flowchart 600, flowchart 800, flowchart 900, flowchart 1000, and/or flowchart 1200 may be implemented as computer program code configured to be executed in one or more processors. Alternatively, client control and management interface 114, plug-in module 116, client control and management interface 502, user interface module 504, device imaging interface 506, deployment manager 726, imaging logic 1104, flowchart 200, flowchart 600, flowchart 800, flowchart 900, flowchart 1000, and/or flowchart 1200 may be implemented as hardware logic/electrical circuitry.

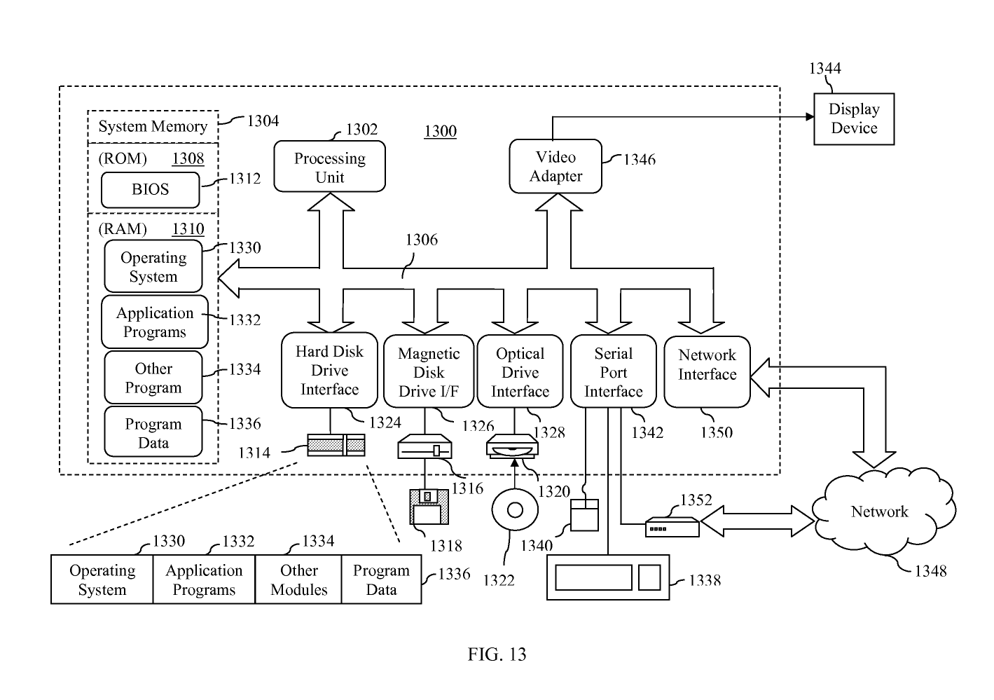

FIG. 13 depicts an exemplary implementation of a computer 1300 in which embodiments of the present invention may be implemented. For example, configuration management system 102, client administration system 104, and/or client device 106 may be implemented in one or more computer systems similar to computer 1300, including one or more features of computer 1300 and/or alternative features. Computer 1300 may be a general-purpose computing device in the form of a conventional personal computer, a mobile computer, or a workstation, for example, or computer 1300 may be a special purpose computing device. The description of computer 1300 provided herein is provided for purposes of illustration, and is not intended to be limiting. Embodiments of the present invention may be implemented in further types of computer systems, as would be known to persons skilled in the relevant art(s).

As shown in FIG. 13, computer 1300 includes a processing unit 1302, a system memory 1304, and a bus 1306 that couples various system components including system memory 1304 to processing unit 1302. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computer 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1330, one or more application programs 1332, other program modules 1334, and program data 1336. Application programs 1332 or program modules 1334 may include, for example, computer program logic for implementing client control and management interface 114, plug-in module 116, client control and management interface 502, user interface module 504, device imaging interface 506, deployment manager 726, imaging logic 1104, flowchart 200, flowchart 600, flowchart 800, flowchart 900, flowchart 1000, and/or flowchart 1200 (including any step of flowcharts 200, 600, 800, 900, 1000, and 1200), and/or further embodiments described herein.

A user may enter commands and information into the computer 1300 through input devices such as keyboard 1338 and pointing device 1340. Other input devices (not shown) may include a microphone, joystick, game pad, satellite dish, scanner, or the like. These and other input devices are often connected to the processing unit 1302 through a serial port interface 1342 that is coupled to bus 1306, but may be connected by other interfaces, such as a parallel port, game port, or a universal serial bus (USB).

A display device 1344 is also connected to bus 1306 via an interface, such as a video adapter 1346. In addition to the monitor, computer 1300 may include other peripheral output devices (not shown) such as speakers and printers.

Computer 1300 is connected to a network 1348 (e.g., the Internet) through an adaptor or network interface 1350, a modem 1352, or other means for establishing communications over the network. Modem 1352, which may be internal or external, is connected to bus 1306 via serial port interface 1342.

As used herein, the terms “computer program medium,” “computer-readable medium,” and “computer-readable storage medium” are used to generally refer to media such as the hard disk associated with hard disk drive 1314, removable magnetic disk 1318, removable optical disk 1322, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1332 and other program modules 1334) may be stored on the hard disk, magnetic disk, optical disk, ROM, or RAM. Such computer programs may also be received via network interface 1350 or serial port interface 1342. Such computer programs, when executed or loaded by an application, enable computer 1300 to implement features of embodiments of the present invention discussed herein. Accordingly, such computer programs represent controllers of the computer 1300.

The invention is also directed to computer program products comprising software stored on any computer useable medium. Such software, when executed in one or more data processing devices, causes a data processing device(s) to operate as described herein. Embodiments of the present invention employ an computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like,

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A configuration management system, comprising:
a device imaging interface configured to transmit a begin request to a plug-in module at a client administration system to begin a deployment job, the plug-in module customized to be capable of managing received deployment jobs for the client administration system, and the plug-in module enabling the deployment job to be performed on at least one client device administered by the client administration system in response to receiving the begin request, including processing an imaging task of the deployment job.

2. The configuration management system of claim 1, wherein the configuration management system further comprises:
a user interface module that generates a user interface that enables the at least one client device to be selected for at least one task in the deployment job, the at least one task including imaging, and to select an image file to be applied to the at least one client in the deployment job, the user interface enabling a plurality of tasks on client devices associated with a plurality of types of client administration modules to be managed.

3. The configuration management system of claim 2, wherein the at least one task includes at least one of a first operating system being deleted from the at least one client, a permanent memory of the at least one client being cleared, a second operating system being installed on the at least one client, a software update being installed on the at least one client, a BIOS being updated on the at least one client, a third-party compliance verification being performed on the at least one client, an anti-virus and/or security scan being performed on the at least one client, or an application being updated on the at least one client.

4. The configuration management system of claim 2, wherein the user interface includes at least one of:
a first user interface element in the user interface that enables the user to configure a schedule for the imaging;
a second user interface element in the user interface that enables the user to select a pause of the imaging;
a third user interface element in the user interface that enables the user to select a resume of the imaging if the imaging is paused;
a fourth user interface element in the user interface that enables the user to select a termination of the imaging; or
a fifth user interface element in the user interface that enables the user to view a progress of the imaging.

5. The configuration management system of claim 1, wherein the device imaging interface includes a deployment manager that is configured to generate an identifier for the deployment job, and to determine one or more device identifiers for the at least one client device.

6. The configuration management system of claim 1, wherein the device imaging interface includes an interface that is configured receive a device identification request from the plug-in module to identify any client devices to image according to the deployment job, and to transmit an indication of the at least one client device to the plug-in module in request to the device identification request.

7. The configuration management system of claim 2, wherein the device imaging interface includes an interface that is configured to receive a status of the deployment job for at least one client from the plug-in module;
the user interface being configured to display the received status.

8. The configuration management system of claim 1, wherein the configuration management system is agnostic to a data format, a protocol, and a transport used by the client administrative system to communicate with the at least one client device.

9. The configuration management system of claim 1, wherein the device imaging interface includes a client registry that records a registration of the plug-in module.

10. A method for managing client devices, comprising:
enabling at least one client device to be selected for imaging, the at least one client device being coupled to a client administration system that administers the at least one client device;
generating a deployment job based the at least one client device selected for imaging; and
transmitting a begin request to a plug-in module of the client administration system to begin the deployment job, the plug-in module having been customized to be capable of managing received, deployment jobs for the client administration system, wherein the plug-in module enables the deployment job to be performed on the at least one client device in response to receiving the begin request.

11. The method of claim 10, said enabling comprises:
providing a user interface that enables a user to select the at least one client device for imaging, and to select an image for the at least one client.

12. The method of claim 11, wherein the imaging includes at least one of deleting a first operating system from the at least one client, clearing a memory of the at least one client, installing a second operating system on the at least one client, or installing a software update on the at least one client.

13. The method of claim 11, wherein said enabling further comprises at least one of:
enabling the user to configure a schedule for the imaging in the user interface;
enabling the user to select a pause of the imaging in the user interface;
enabling the user to select a resume of the imaging in the user interface if the imaging is paused;
enabling the user to select a termination of the imaging in the user interface; or
indicating a progress of the imaging in the user interface.

14. The method of claim 10, wherein said generating a deployment job comprises:
generating an identifier for the deployment job;
determining one or more device identifiers for the at least one client device; and
associating an image file with the deployment job.

15. The method of claim 10, further comprising:
receiving a request from the plug-in module to identify any client devices to image in response to the begin request; and
transmitting an indication of the at least one client device to the plug-in module in response to the received request.

16. The method of claim 10, further comprising:
receiving a status of the deployment job for at least one client from the plug-in module.

17. The method of claim 16, further comprising:
displaying the received status in a user interface.

18. A plug-in module for a client administration system, comprising:
a manager interface configured to enable communications with a configuration management system, the communications including a begin request received from the configuration management system for the plug-in module to begin a deployment job; and
imaging logic configured to enable the deployment job to be started on at least one client device associated with the client administration system in response to receiving the begin request.

19. The plug-in mode of claim 18, wherein the deployment job is an imaging of the at least one client;
wherein the imaging logic is configured to pause the imaging in response to a pause request received by the manager interface from the configuration management system;
wherein the imaging logic is configured to resume the imaging in response to a resume request received by the manager interface from the configuration management system; and
wherein the imaging logic is configured to terminate the imaging in response to a terminate request received by the manager interface from the configuration management system.

20. The plug-in module of claim 18, wherein the imaging logic is configured to determine a status of the deployment job at the at least one client, and the manager interface is configured to transmit the determined status to the configuration management system.
